(19) United States
(12) Patent Application Publication
(10) Pub. No.: US 2019/0268672 A1
(43) Pub. Date: Aug. 29, 2019

(54) COORDINATED MULTIPLE-DEVICE CONTENT DELIVERY

(71) Applicant: Comcast Cable Communications, LLC, Philadelphia, PA (US)

(72) Inventor: Galen Trevor Gattis, Sunnyvale, CA (US)

(21) Appl. No.: 15/903,854

(22) Filed: Feb. 23, 2018

(51) Int. Cl. H04N 21/858; H04N 21/266

(52) U.S. Cl. CPC H04N 21/858; H04N 21/266

(57) ABSTRACT

Methods, systems, and apparatuses are described for coordinating output of related media content on a variety of devices and device types is disclosed. A content distribution network may store associations between a primary media content file and a set of rules. A rules engine may be initialized with the set of rules and a set of facts pertinent to the output of the content. The set of facts may include information describing secondary devices associated with a viewer of the content. Events, such as those associated with output of the primary media content, may trigger output of secondary media content on the associated devices.

### BACKGROUND

Traditional media content, such as movies and television content, may be sent to a user via a network. Up to this point, the nature of media content sent via networks has been linear. For example, content may be sent to a user in a linear stream, and may be consumed by the user from beginning to end on a single device.

It has become more common for various user devices to be connected to a network. For example, devices such as lights, thermostats, toys, and so forth may be present in the user's home and connected to the user's network. Lights, thermostats, appliances, and so on might be connected to the user's home network, for example. Typically, the purpose of these connections is related to the primary purpose of the device, such as turning a light on and off, adjusting the temperature, monitoring the status of an appliance, and so on. However, neither these devices nor their connection to a network are utilized in the presentation of content, which as noted above is typically sent in linear fashion for presentation on a single device. These and other shortcomings are addressed in the present disclosure

### SUMMARY

Systems and methods are described for distributing media content over a distribution network to a consumer. The media content may comprise a primary content portion, such as a movie or television content played back on a user's media device, and various secondary content portions. The secondary content portions may include additional media content. The media content may, for example, comprise audiovisual elements that may be played back on a secondary display screen or audio speaker. The secondary content portions may include device interaction content. The device interaction content may comprise effects triggered via interaction with network-connected devices, potentially including devices such as lightbulbs, phones, and toys.

Primary and secondary content may be associated with a set of rules. A point in time in the primary content may be associated with an event that is triggered when output of the primary content reaches the point in time. The rules engine may then process the event in view of other events or facts, and possibly trigger further events. These events may include triggering the output of secondary content on a device that is within the user's environment. While the secondary content is playing, the output of the primary content may be stretched or otherwise extended until output of the secondary content has completed. Normal output of the primary content may be resumed in response to the secondary content having been output.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 is a diagram of an example content distribution system 100.

FIG. 2 is a diagram of example operation of a rules engine.

FIG. 3 is a diagram showing examples of output-generated events.

FIG. 4 is a diagram showing an example of content stretching.

FIG. 5 is a diagram showing example output of primary content and related secondary content.

FIG. 6 is a flow diagram showing example operation of a device hub.

FIG. 7 is a flow diagram showing an example of output of related primary and secondary content on a content distribution network.

FIG. 8 is a diagram of an example computer.

### DETAILED DESCRIPTION

Methods, systems, and apparatuses are described for the output of media content. The media content may comprise related primary and secondary content. For example, the primary content may comprise movie or television content that is played back on a primary device. The secondary content may comprise audiovisual media content, device interaction content, or device effect content. The interaction content may include effects triggered via interaction with a device, such as answering a telephone call, interacting with device controls, and so on. The device effect content may include light bulbs turning on or off, adjustments to device settings, and so forth.

A rules engine may be instantiated and initialized when output of primary content commences. The rules engine may be initialized with a set of rules associated with the primary content and a set of facts associated with a consumer of the primary content. Content output operations may be performed on a streaming server for the primary content, a streaming server for the secondary content, and a device hub for interaction with devices associated with the consumer of the primary content.

Media content may be associated with a set of rules. For example, a primary content file may be associated with a set of rules. In addition, a point in time in the primary content may be associated with a first event that is triggered when output of the primary content reaches the point in time. The first event may, for example, pertain to a plot point or story element of the primary content that may be enhanced by the output of additional content. For example, a movie might contain a scene in which the leading character initiates a telephone call. The first event might be mapped to the point in time in the movie where the telephone call is placed.

In response to an occurrence of the event, another event may indicate that a call be initiated to a real-world telephone in the consumer's environment. For example, a rules engine may match characteristics, observations, or other data to a set of rules. This is sometimes described as matching facts to rules, or determining that the facts correspond to a set of rules. The characteristics, observations, or other data may be matched to the set of rules associated with the content, and it may thereby be determined that a rule indicates that the real-world telephone call should be established. The characteristics, observations, or other data may include that the first event has been triggered, and that devices are present and available in the consumer's environment for playing secondary content.

The secondary content may then be played by interacting with a device hub and/or a streaming server to request that the secondary content be played. In the case of the real-world telephone call, for example, the rules engine may send instructions to a device hub to place a telephone call and to play an audio file. For example, a streaming server might be instructed to stream the secondary content to a smartphone or personal computer.

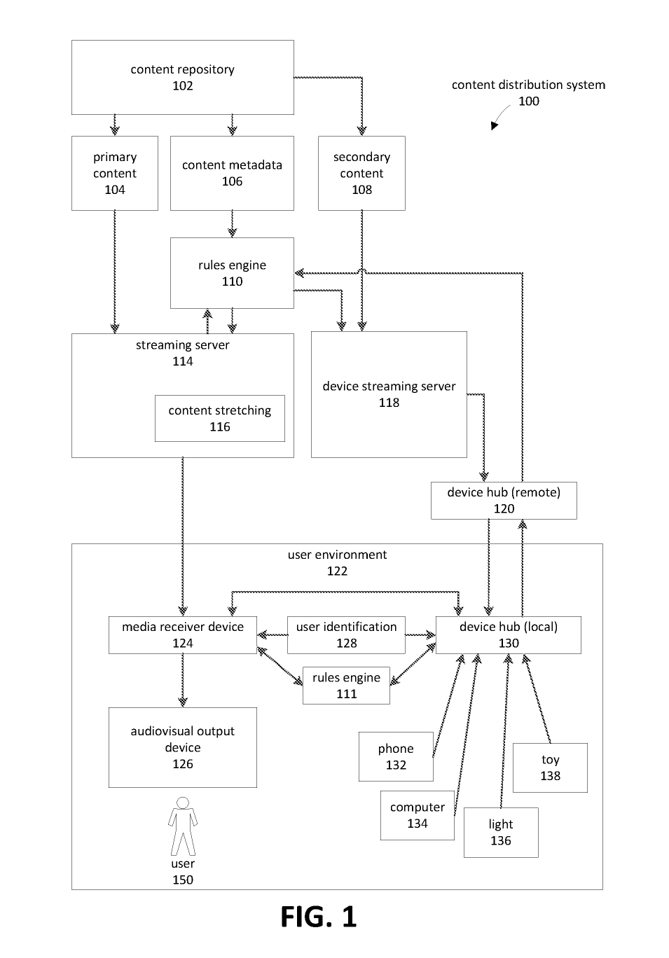

FIG. 1 shows an example of a content distribution system 100. The content distribution system 100 may send primary content 104 to a media receiver device 124 for display on an audiovisual output device 126. The primary content 104 may include or comprise media content such as movies, television programs, and so forth. The primary content 104 may be content that has been requested by a user 150. For example, the user 150 may have requested to view a movie, television, or audio program. The primary content 104 may be associated with secondary content 108 that is associated with the primary content 104. This may include aspects of the viewing or listening experience of user 150 that may be enhanced by the addition of the secondary content 108.

The media receiver device 124 may include devices such as set-top boxes, cable cards, devices with software for receiving media from Internet sources, and so forth.

The media receiver device 124 may be associated with, or may comprise, a user identification component 128. The user identification component 128 may establish the identity of a user 150 and confirm that the user 150 is viewing the primary content 104. The media receiver device 124 may, for example, use voice-based identification, speech-based identification, or credential-based identification to identify the user 150.

Although not explicitly depicted by FIG. 1, the user identification component 128 may communicate with a component external to the user environment in order to obtain or process information permitting the identity of the user to be established.

The user identification component 128 may communicate information indicative of the identity of the user 150 to the media receiver device 124. The media receiver device 124 may communicate the information to other components of the content distribution system 100, such as the rules engine 110. The rules engine 110 may use the information as an element of the set of facts to which rules are matched by the rules engine to determine to trigger an event.

The content distribution system 100 may use the information to maintain state information for the rules engine 110 that is pertinent to a user's 150 viewing of the audiovisual content. For example, state information for the rules engine 110, pertaining to the user's 150 viewing of the primary content 104, may be saved for subsequent retrieval when the user 150 suspends viewing of the primary content 104. In some cases, the user identification component 128 may anonymize the information for use by the content distribution system 100.

The audiovisual output device 126 may include devices such as televisions, computer monitors, tablet or laptop screens, audio receivers, and so forth. In some cases, the media receiver device 124 may be combined with the audiovisual output device 126 as an integrated component. For example, a personal computer, tablet, or smartphone may comprise a media receiver device 124 and an audiovisual output device.

The primary content 104 may be stored in a content repository 102. The content repository 102 may comprise one or more computing devices and associated storage devices for maintaining a collection of media content. For example, the content repository 102 might comprise one or more server computers each connected to a storage device, to a network addressable storage (“NAS”) system, or other storage systems.

The primary content 104 may be stored on the content repository 102 with associated content metadata 106. The content metadata 106 may be stored in a manner that permits it to be retrieved based on the identity of the primary content 104. The content metadata 106 may define information pertinent to corresponding primary content 104 stored in the content repository 102. For example, a file comprising a movie might be associated with a file comprising metadata about the movie.

The content metadata 106 may include rules associated with corresponding primary content 104. The rules may be used to initialize an instance of a rules engine 110. The rules engine 110 may receive various facts that may be matched to a set of rules. The set of facts may include indications that certain events have or have not occurred. By matching rules to the set of facts, additional events may be triggered.

Output of primary content 104 may trigger an event that may be provided to the rules engine 110 as input, e.g. as one of the set of facts to which rules are matched. The primary content 104 may, for example, have events associated with various points in time within the content. For example, a first event might be associated with the beginning of the movie, a second event might be associated with a point in time in the content when some dramatic event occurs, and a third event might be associated with the end of the movie.

The output of primary content 104 may include the display, playback, or presentation of the primary content 104 on a device. In the example of audiovisual content, output may comprise displaying visual output on a screen and playing audio content through a speaker. Output of secondary content 108 may comprise similar operations. Alternatively, output of secondary content 108 may comprise other operations, such as turning a light bulb on, adjusting a device setting, and so on.

Events triggered by the rules engine 110 may cause other components of the content distribution system 100 to perform additional operations associated with the output of the primary content 104. The rules engine 110 may, for example, trigger an event that causes an alteration of the output of primary content 104 on the audiovisual output device 126. The rules engine 110 may also, for example, trigger an event that causes the device streaming server 118 to send secondary content 108 to a device associated with the user environment 122.

The user 150 may interact with a device in the user environment 122 to trigger an event that may be processed and applied by the rules engine 110. For example, the user 150 may view a telephone number displayed in the primary content 104 and call the displayed telephone number using the phone 132. A local device hub 130 or remote device hub 120 may receive an indication that the call has been made and send a message indicative of the event to the rules engine 110. The rules engine 110 may then match the event to a rule that, for example, triggers output of secondary content 108 on a secondary device and/or alters output of the primary content 104.

A device such as phone 132 may process audio input and cause an event to be triggered and processed by a rules engine 110, 111 in response to the audio input. For example, speech-to-text processing may be applied to audio input to determine a command expressed vocally by a user 150. The content of the command may be provided as a set of facts to a rules engine 110, 111. For example, the spoken command might be “Open the door!” Speech-to-text processing might be applied to the spoken command to obtain “open door,” and this could be provided to a rules engine 110, 111. The rules engine 110, 111 might then trigger output of secondary content in which a character in the primary content 104 is seen to open the door. Additionally or alternatively, the output of the primary content 104 might be altered to show the character opening the door. Additionally, a local rules engine 111 may be used in order to avoid transmission of user-generated text outside of the user environment 122.

The secondary content 108 may include various interactions or uses of a device that are, in some way, associated with the primary content. In an example, secondary content 108 may include causing a phone 132 to ring, causing a light 136 to flash, causing an audio or visual signal to be played on a toy 128, or displaying interactive audiovisual content on a computer 143. In some cases, secondary content 108 may refer to audiovisual content such as commercials, alternative views of scenes presented in the primary content, and so forth.

Output of the secondary content 108 on a secondary device 132-138 may be triggered through a device hub 120, 130. In FIG. 1, a remote device hub 120 is depicted as being an element of the content distribution system 100, and a local device hub 130 is depicted as being located within the user environment 122. A device hub, as used herein, may refer to either one of the depicted device hubs, or to the two acting in combination. A particular device may be reachable only through a device hub 120, 130 located within or outside of the user environment 122. For example, in some cases the remote device hub 120 may be able to initiate a telephone call through a national or regional telephone network, while this may not be possible for the local device hub 130. Similarly, the local device hub 130 may be able to initiate interaction with a toy 138 or light 136 in the user environment 122, whereas the remote device hub 120 may not be able to.

The content distribution system 100 may include a device hub 130 operative within the user environment 122 and/or a device hub 120 operative at a location remote to the user environment 122. A device hub may receive information indicative of devices capable of playing secondary content 108. The information may include information usable to connect to the device and issue an instruction to play the secondary content 108. A device hub 120, 130 may receive instructions to play the secondary content 108 on a suitable device. The device hub 120, 130 may determine which device is most suitable.

The device hub 120, 130 may provide facts to the rules engine 110 concerning which devices are available. This may be done prior to or subsequent to an event indicating that the secondary content 108 should be played. For example, a device hub 120 might indicate that phone 132 and computer 134 are available for playing the secondary content 108. Based on this information, the rules engine might subsequently trigger an event indicating that the secondary content 108 should be played on the phone 132. However, at this time the device hub 120, 130 might determine that the phone 132 is no longer available. The device hub 120, 130 might notify the rules engine, which in turn might trigger an additional event indicating that the computer 134 should play back the secondary content 108.

The device hub 120, 130 may also broker connections between a device streaming server 118 and a secondary device, such as a phone 132. For example, secondary content 108 might comprise audiovisual content that may be played back on the phone 132 or computer 134. The device streaming server 118 may be instructed by the rules engine 110 to stream content to the phone 132. The device streaming server 118 may be placed in communication with the phone 132 via the device hub 120, 130. The device streaming server 118 may then transmit the secondary content 108 to the phone 108.

A device 132-138 may provide a capability for initiating events that may be processed by a rules engine 110 to trigger further events, such as output of secondary content 108. For example, a phone 132 might be configured to execute an application providing various mechanisms for initiating an event. Similarly, the phone 132 might provide for output of secondary content 108 and provide a capability for receiving input during or in response to the output of the secondary content.

Returning now to the operation of the streaming server 114, the streaming server 114 may comprise a content stretching component 116. The content stretching component may delay progression of the output of the primary content 104 while secondary content 108 is playing.

The content stretching component 116 may cause output of the primary content 104 to be displayed on the audiovisual output device 126 in a paused state.

The content stretching component 116 may cause output of a loop of content on the audiovisual output device 126. The loop may be of the primary content 104, or of additional content related to the secondary content. For example, if the secondary content comprises causing the phone 132 to ring, additional content displaying the message “Answer the phone!” might be presented on the audiovisual output device 126.

The rules engine 110 may trigger an event that causes the content stretching 116 component to end the period of content stretching and to cause output of the primary content 104 to continue. The device hub 120, 130 may send to the rules engine 110 information indicating that output of the secondary content 108 has completed, causing the rules engine 110 to trigger the event. Alternatively, other events such as a timeout period elapsing or the user 150 requesting a resumption of output may cause the rules engine to trigger the event. Note that in some cases, output of the primary content may resume without the rules engine 110 triggering an event. In such cases, the rules engine 110 may be notified ex post facto that output of the primary content 104 has resumed.

A rules engine 111 may be operative in the user environment 122, and may be referred to as a local rules engine. The local rules engine 111 may operate similarly to the rules engine 110 of the content distribution system 100, which may be referred to as a remote rules engine. Additionally, the local rules engine 111 may perform some or all of the functions of the remote rules engine 110, and the remote rules engine 110 may be omitted. The local rules engine 111 may apply rules pertaining to facts and data pertinent to the user environment 122. For example, the local rules engine 111 may be configured with facts and rules pertaining to the user 150 and to the devices 132-138 available in the user environment 122, while the remote rules engine 110 may be configured with facts and rules that are not specific to the user 150 or the user environment 122. Facts and rules pertaining to the output state of the primary content 104 and secondary content 108 may be applied by the local rules engine 111.

The media receiver device 124 may host the local rules engine 111. The media receiver device 124 may store data and rules used to configure the local rules engine 111, and act (sometimes in concert with the device hub 130) to notify the local rules engine 111 of events.

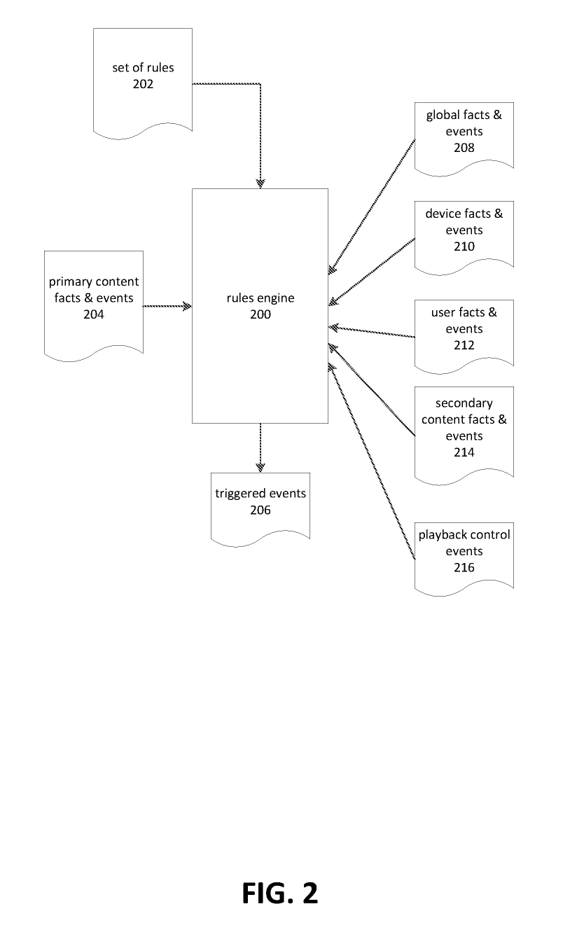

FIG. 2 is a diagram of example operation of a rules engine. The depicted operations may be performed by a remote rules engine 110 and/or a local rules engine 111. In FIG. 2, a rules engine 200 may comprise one or more modules for the application of a set of rules to a set of facts. Application of the set of rules to the set of facts may involve pattern matching between the rules and facts, or put another way determining that one or more facts are applicable to or correspond to one or more rules. For example, a rule to “trigger event X when Y happens” may involve matching the condition “Y” to a set of facts to determine whether or not “Y” has happened, and if so to trigger the event X. The matching may involve forward and backward chaining of rules and facts. For example, the rules engine might deduce that “Y” has happened because of an additional rule of “Y happens when Z has happened.”

The rules engine 200 may, in response to the application of a set of rules to a set of facts, cause an event 206 to be triggered. In some cases, triggering an event may result in a modification to the state of the rules engine 200, such that an additional fact—that of the event being triggered—may be used in subsequent application of the rules. In other cases, the rules engine may send information describing the event to another componednt of the content distribution network, such as a device streaming server 114, 118. The information might in some cases cause the streaming server 114, 118 to start, stop, or pause, or stretch content output.

The rules engine 200 may be initialized using a set of rules 202. The set of rules may be associated with primary content that is to be played back to a user. The rules engine 200 may be further initialized to with, for example, global facts and events 208, device-related facts and events 210, user-related facts and events 212, secondary content facts and events 214, and output control events 216.

The global facts and events 208 may comprise information that is not content-specific or user-specific. Examples include, but are not limited to, information related to current events, advertising, program listings, and so forth.

The device facts and events 210 may comprise information related to the capabilities of various devices capable of playing some form of secondary content. Included in this category is information describing the devices associated with a user, and the ability of those devices to play back secondary content.

The user facts and event 212 may comprise information related to the identity of a user viewing the primary content. This may include information regarding a user's progression through output of the primary content. For example, a fact supplied to the rule engine 200 might pertain to the latest point in the content that the user has viewed. If the user rewinds or restarts viewing the primary content, certain pieces of secondary content might not be activated during the subsequent viewing, up to the latest point in time. This might be reflected in a rule that states that a piece of secondary content should be played if output of the primary content reaches a particular point in time, and that time is later than the latest point in time already viewed by the current user.

The secondary content facts and events 214 may include information pertaining to the output state of secondary content or a user's interaction with secondary content. In some cases, for example, a fact might indicate that a user has already interacted with a piece of secondary content. In other cases, a fact might indicate that a user has not interacted with the secondary content.

The output control events 216 may comprise commands indicative of playing, pausing, fast-forwarding, rewinding, or stopping output of content. The output control events 216 may, for example, be sent from the media receiver device 124, phone 132, or computer 134 depicted in FIG. 1. The output control events 216 may, for example, be initiated by a user 150 who interacts with a remote control device, smartphone application, and so forth to control output of primary content 104 or secondary content 108. This interaction may be processed by the media receiver device 124, phone 132, or computer 134 and forwarded as an event to a rules engine 110 or 111.

The facts and events 208-216 may be updated over time. For example, the facts and events 208-216 may be updated as output of primary or secondary content progresses. Examples include progression through output of primary content, a user entering or leaving a viewing area for the primary content, updates to the location of the user, new devices being made available or devices becoming unavailable, completing output of secondary content, and so on.

In some cases, secondary content may have an interactive component, such as a request that the user provide input in response to output of media associated with the secondary content. For example, secondary content might comprise output of a short video on a smartphone, after which the user is requested to provide input. The rules engine 200 might receive notification of this event sent from the smartphone, in some cases via a device hub 120, 130.

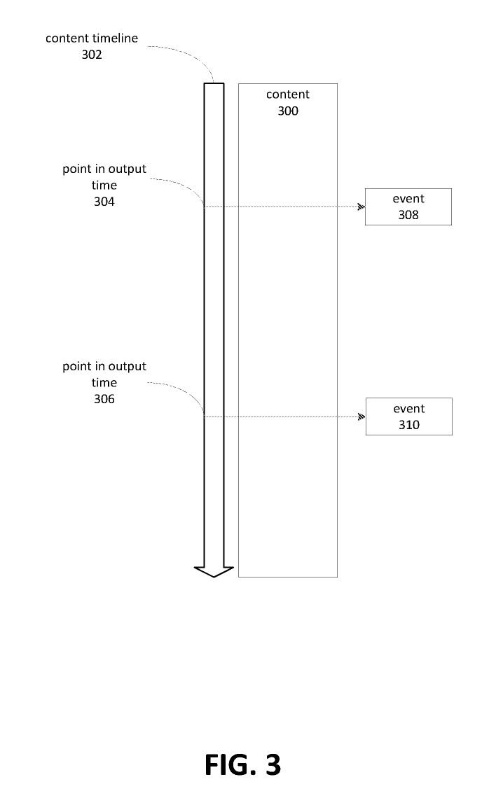

Output of primary or secondary content may be associated with facts and events that may be sent to the rules engine. FIG. 3 is a diagram showing examples of output-generated events.

Content 300 may correspond to primary or secondary content, including but not limited to movies, television programs, music, device interactions, and so forth. Output of content may be according to a content output timeline 302. Typically, content is played back along a timeline associated with various points in time in the output 304, 306. For example, a piece of content that is an hour long might start at the point in time 00:00:00 (HH:MM:SS) and end at 01:00:00.

Events 308, 310 may be associated with points in output time 304, 306. For example, in FIG. 3 a first point in time 304 may be associated with a first event 308, and a second point in output time 306 may be associated with a second event 310.

A content distribution system may track associations between the points in output time 304, 306 and the events 308, 310 using stored content-related metadata. For example, if a movie is stored as a file, a related file containing content-related metadata might also be stored. The content-related metadata might include a mapping between points in output time and events that may be generated at that point in time when the content is played back.

Output of primary content may at times be stretched to accommodate output of secondary content. The associations between points in output time 304, 306 and events 308, 310 may typically be made to disregard stretched output time. Events may thus be associated with plot points within the content without regard to whether or not content stretching has occurred. There may, however, be times when events are associated with total elapsed time, including whatever content stretching has occurred.

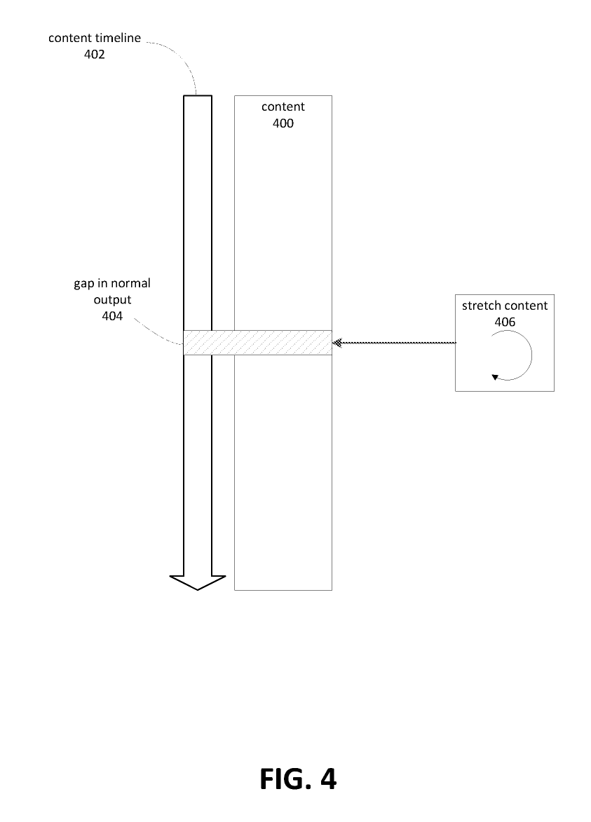

FIG. 4 is a diagram showing an example of content stretching. The content 400 may be played back on a media receiver, such as a set-top box. As noted regarding FIG. 3, output of content may proceed according to a content timeline 400. At some point during output of the primary content, the media receiver may be instructed to suspend output of the content 400, creating a gap in normal output 404. The media receiver may be further instructed to play alternate content during this gap 404. The stretch content 406 may be inserted into the gap by the media receiver. The stretch content 406 may, for example, be content of a similar type to content 400 with a looping or repeating aspect, such that it may be repeated for the length of the gap. Various other types of stretch content might be used, such as slow motion, rewinding, static images, and so forth.

Output stretching is described herein primarily regarding primary content that is stretched to accommodate output of secondary content. However, in some cases output of secondary content may also be stretched. Secondary content may be stretched to accommodate output of other secondary content, or for output of the primary content. For example, output of primary content may be stretched while a first portion of secondary content is played, followed by a period in which the secondary content is stretched while the primary content is played, and so on.

Content stretching may be supported by the content distribution system in various ways. The content distribution system may send stretch content through an on-demand, content delivery system. The stretch content may be retrieved from a content repository based on key values comprising the identity of the content being stretched and the point in time that is being stretched. The content may be retrieved based on a content identifier determined by a rules engine based on a variety of factors. These may include the identity of the content being stretched, the point in time of the content that is being stretched, the device on which secondary content is being played, and the state of the rules engine. For example, the rules engine might determine to play back different stretch content when the associated secondary content is first played back, versus when the associated secondary content is played back a second time. Similar, the rules engine might determine to play back different stretch content when it has determined that the secondary content should be played back on a phone, compared to when the secondary content is played back on a computer.

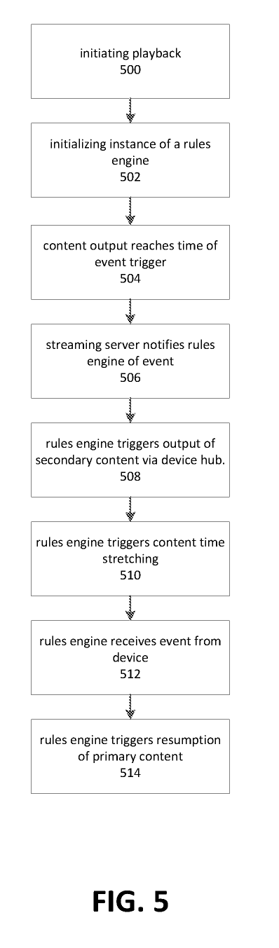

The operation of the content distribution network may be better understood in view of FIG. 5, which is a diagram showing example output of primary content and related secondary content. Although depicted as a sequence of blocks, the depicted sequence should not be construed as limiting the scope of the present disclosure to embodiments adhering to the depicted sequence. In various cases, aspects, and embodiments, at least some of the blocks and depicted operations may be altered, omitted, reordered, or performed in parallel.

Block 500 depicts initiating output of primary content. The content distribution system may receive a request to view primary content, such as a movie or television program. In response, a streaming server may begin to transmit the content, over a network, to a media receiver such as a set-top box or smartphone.

As depicted by block 502, the content distribution system may initialize an instance of a rules engine. The rules engine may be maintained on the streaming server and associated with the streaming of the primary content, such that the rules engine is instantiated when the streaming starts, and deactivated or deleted when the streaming ends.

Instantiating the rules engine may involve loading a set of rules, loading a set of associated facts, and linking the rules engine to event sources and destinations.

The content distribution system may identify a set of rules associated with the primary content and supply them to the rules engine. The rules may be retrieved from a content repository. The rules may, for example, be stored in metadata associated with the content that is loaded when the streaming of the content begins. The rules engine may parse the rules during the initialization process.

The content distribution system may retrieve facts pertinent to the set of rules, and continue the initialization process by loading the set of facts into the rules engine. The facts may be identified and loaded through various means, including a set of initialization rules defined by the set of rules and applied by the rules engine. The facts may also include facts retained from a prior session. When output of the primary content is paused, the content distribution system may cause the state of the rules engine, as reflected by as of current facts, to be stored for later retrieval. The facts may be retrieved and re-loaded into a new instance of a rules engine when output of the primary content is restored.

Block 504 depicts content output reaching a time associated with an event. Certain points in time in the content may be associated with events. The association may be maintained in a content metadata file associated with the primary content. In some cases, the primary content may have event information embedded within it.

Block 506 depicts that the streaming server may notify the rules engine of the event. When the streaming server reaches a point in time that is associated with an event, it may send a signal to the rules engine describing the event. The event information may include an identifier of the event. The rules engine may then use the identifier to trigger one or more additional events based on an application of the set of rules to a set of facts that now reflects the occurrence of the new event.

Block 508 depicts that the rules engine may trigger output of secondary content on a device. As noted, the output may be generated by application of the set of rules to the current set of facts, including the fact of output having reached a point in time associated with an event.

The rules engine may transmit instructions to begin output of secondary content on a device. The rules engine may, for example, respond to an event associated with the content output by instructing a streaming server for secondary content to begin output back content to a secondary device. Information pertinent to the output, such as the devices available to play secondary content, may be known to the rules engine and used to determine whether to play secondary content, on which device to play the secondary content, and how to cause the device to play secondary content.

The rules engine may send instructions to play the secondary content to a device via a device hub. The device hub may collect and maintain information describing devices available to a user, collect information concerning which devices the user has made available for secondary content, establish a communications channel to a device, and enable communication between other modules of the content distribution system and a device. For example, the device hub may enable a streaming server to transmit secondary content to a device by acting as a network bridge, or by facilitating more direct communication between the streaming server and the device.

While the secondary content is played on a device, the output of the primary content may be “stretched.” Block 510 depicts that the rules engine may trigger content stretching after initiating output of the secondary content. The rules engine may determine to initiate the content stretching based on application of the set of rules to the set of facts, including that of secondary content output being initiated and in-progress.

Block 512 depicts that the rules engine may receive an event or fact from the device on which the secondary content was played. The rules engine may be notified that output of the secondary content has been completed, or has been interrupted. In some cases, the rules engine may receive notification that the user has performed a requested action associated with the secondary content. For example, the secondary content might request that the user enter a code or some other piece of information, initiated a telephone call, sent an email, and so forth.

Block 514 depicts that the rules engine may trigger a resumption of output, or an adjustment of output, in response to determining that output of the secondary content has completed. Having been notified that output of the secondary content has completed, and of any pertinent results or feedback from the user, the rules engine may apply these facts to determine a course of progression for the primary content. In some case, the rules engine may determine that output of the stretch content should be discontinued, and that normal output resumed. The rules engine might also adjust output of the primary content, for example by causing a different, non-continuous portion of the primary content to be played. This may, for example, allow output of the primary content to proceed in an interactive, non-linear manner.

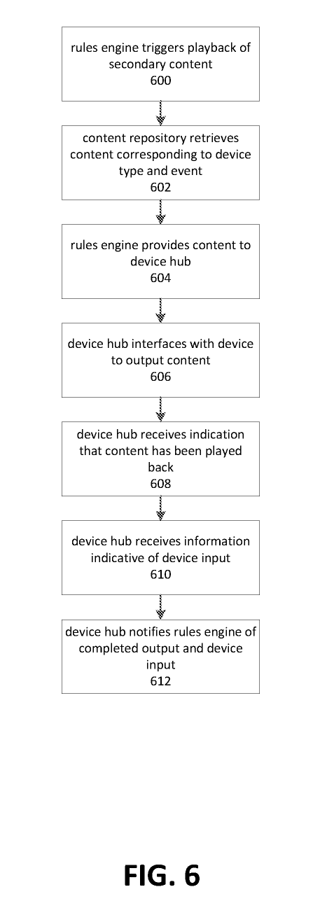

FIG. 6 is a flow diagram showing example operation of a device hub. Although shown as a sequence of blocks, the sequence should not be construed as limiting the scope of the present disclosure to embodiments adhering to the sequence. In various cases, aspects, and embodiments, at least some of the blocks and operations may be altered, omitted, reordered, or performed in parallel.

A rules engine, such as the rules engine 110 shown in FIG. 1, may trigger output of secondary content as shown by block 600. The rules engine may, for example, identify a piece of secondary content consistent with a storyline of the primary content and determine that the secondary content may be played.

As shown by block 602, a content repository, such as the content repository 102 shown in FIG. 1, may retrieve a version of the identified content that corresponds to a selected device type. The rules engine may identify a type of device on which the identified content may be played. The rules engine may have identify the type of device based on facts related to which devices are available for displaying the secondary content to the user 150.

In some cases, a local device hub 130 may participate in determining the device type. For example, the device hub 130 may determine which devices are available to display the secondary content and transmit that information to the rules engine. In other cases, the device hub 130 may determine which device should play secondary content, and notify the rules engine 110 of the determination.

The content repository 102 may then provide a version of the content that is compatible with the selected device type to a streaming server, such as the device streaming server 118 that is shown in FIG. 1. These operations are shown by block 604.

The device hub may interface with the device to play back the content, as shown by block 606. The operations performed to interface with the device may vary depending on the content to be displayed and the type of device.

For example, interaction with a device may be via an API or protocol which activates functions of the device. For example, the selected version of secondary content may involve dimming or turning off a lightbulb via a home automation interface. Alternatively, the selected version of secondary content may involve triggering a phone call and playing a recording if an when the call is answered. In some cases, output of the secondary content may also involve receiving device-specific input actions. For example, in the case of the phone call, answering the phone, entering a requested code, and so forth may be a component of playing back the secondary content.

The device hub may receive an indication that the secondary content has been played, as shown by block 608. More generally, the device hub may receive an indication that output of the content has reached a point at which output of the primary content may proceed. As shown by block 610, the device hub may also receive an indication of input provided to the device. For example, the device hub may receive text, speech, or other input collected by the device during or in response to output of the secondary content.

The device hub may notify the rules engine 110 of the completed output, as shown by block 612. The device hub may also provide the rules engine 110 with results of the output, such as text, speech, or other input provided to the device during or in response to output of the secondary content.

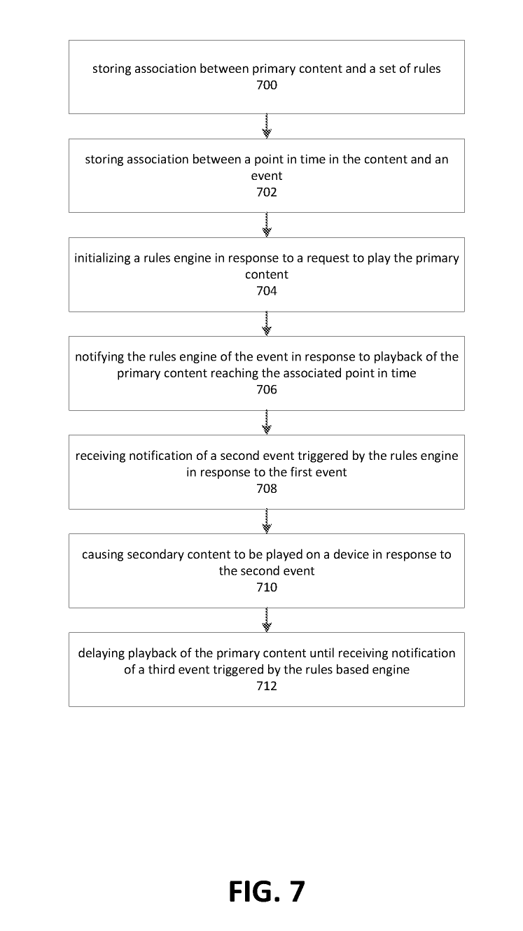

FIG. 7 is a flow diagram showing an example of output of related primary and secondary content on a content distribution network. Although shown as a sequence of blocks, the sequence should not be construed as limiting the scope of the present disclosure to embodiments adhering to the sequence. In various cases, aspects, and embodiments, at least some of the blocks and operations may be altered, omitted, reordered, or performed in parallel.

As block 700 shows, an association may be stored between primary content, such as a movie or television program file, and a set of rules. For example, with reference to FIG. 1, a content repository 102 may maintain files containing primary content and corresponding content metadata 106. The content metadata 106 may be stored in a file linked to, associated with, or embedded in a corresponding primary content 104 file. The set of rules may be a component of the content metadata 106.

An association between a point in time in the primary content and a first event may be stored, as shown by block 702. The event may be one of a set of facts matched to the set of rules by the rules engine 110. The point in time in the primary content may refer to refer to a time in the output of the content at which a plot development occurs. Note that the system may adjust these times to account for content stretching, so that the event is triggered at the same time as the plot development in the primary media content, regardless of whether or not output of the primary content has previously been stretched.

The rules engine 110 may be initialized in response to a request to play the primary content, as shown by block 704. The rules engine 110 may also be initialized with a set of facts associated with a viewer of the primary content. For example, the set of facts may include descriptions of devices available for use in the user environment 122 which have been collected by a local device hub 130. The set of facts may also include the viewer's preferences regarding device interaction.

The rules engine 110, 111 may be enabled or disabled in response to input from various devices. For example, a media receiver device 126, phone 132, or computer 134 might transmit a message indicating that the output techniques described herein should be employed. The output techniques may be activated in response to a particular secondary device, such as computer 134 or phone 132, being available. User input into these devices 132, 134 may then trigger transmission of a message which indicates that output of secondary content may be enabled, and that consequently a rules engine 110, 111 should be initialized. Similarly, when a secondary device such as the phone 132 or computer 134 is no longer available, the rules engine 110, 111 might be deactivated. Deactivating the rules engine may comprise unloading the rules engine from the memory of a computing device on which it operates.

The rules engine 110 may be notified of the first event, as shown by block 706. The first event, as noted, may be associated with a point in time of the primary content. When output reaches that point in time, the rules engine may be notified of the event and the event may be stored with other facts to be considered by the rules engine 110. The rules engine may then attempt to match its set of rules to its current set of facts. This may result in the triggering a second event associated with the output of secondary content. Block 708 shows receiving a notification of this second event. Note that the rules and facts applied by the rules engine may influence which secondary content is played and which device is used to play the secondary content. For example, a fact considered by the rules engine might be a viewer preference to avoid use of the telephone at certain times of day.

Secondary content may be played on a device in response to the second event, as is shown by block 710. The rules engine 110 may transmit instructions to a device hub 120, 130 and/or device streaming server 118 to initiate output of the content.

Output of the primary content may be delayed until notification is received of a third event, as shown by block 712. The third event may be triggered by the rules engine in response to completing output of the secondary content on the device. Output of the primary content may then resume.

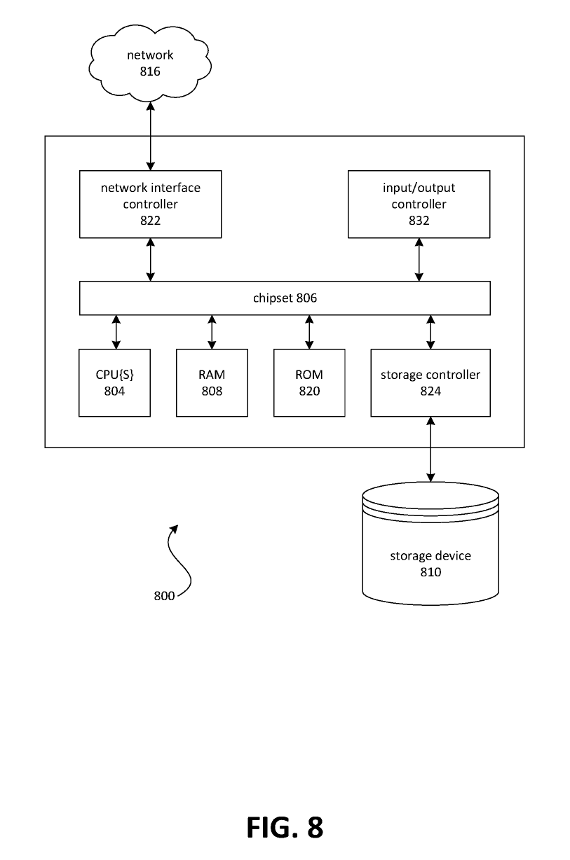

FIG. 8 is a diagram of an example computing device. This may include a server, desktop computer, network appliance, or other computing device, and may be utilized to execute any aspects of the computers described herein, such as, for example, to implement aspects of the operating procedures of FIGS. 5, 6, and 7.

A computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. CPU(s) 804 may be standard programmable processors that perform arithmetic and logical operations necessary for the operation of computing device 800.

CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

CPU(s) 804 may, in some cases, be augmented with or replaced by other processing units, such as GPU(s) 805. GPU(s) 805 may comprise processing units specialized for but not necessarily limited to highly parallel computations, such as graphics and other visualization-related processing.

Chipset 806 may provide an interface between CPU(s) 804 and the remainder of the components and devices on the baseboard. Chipset 806 may provide an interface to a random access memory (RAM) 808 used as the main memory in computing device 800. Chipset 806 may further provide an interface to a computer-readable storage medium, such as a read-only memory (ROM) 820 or non-volatile RAM (NVRAM) (not shown), for storing basic routines that may help to start up computing device 800 and to transfer information between the various components and devices. ROM 820 or NVRAM may also store other software components necessary for the operation of computing device 800 in accordance with the aspects described herein.

Computing device 800 may operate in a networked environment using logical connections to remote computing nodes and computer systems through local area network (LAN) 816. Chipset 806 may include functionality for providing network connectivity through a network interface controller (NIC) 822, such as a gigabit Ethernet adapter. NIC 822 may be capable of connecting the computing device 800 to other computing nodes over network 816. It should be appreciated that multiple NICs 822 may be present in computing device 800, connecting the computing device to other types of networks and remote computer systems.

Computing device 800 may be connected to a mass storage device 828 that provides non-volatile storage for the computing device 800. Mass storage device 828 may store system programs, application programs, other program modules, and data, which have been described in greater detail herein. Mass storage device 828 may be connected to computing device 800 through a storage controller 824 connected to chipset 806. Mass storage device 828 may consist of one or more physical storage units. Storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

Computing device 800 may store data on mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether mass storage device 828 is characterized as primary or secondary storage and the like.

For example, computing device 800 may store information to mass storage device 828 by issuing instructions through storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. Computing device 800 may further read information from mass storage device 828 by detecting the physical states or characteristics of one or more particular locations within the physical storage units.

In addition to mass storage device 828 described above, computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that can be used to store the desired information in a non-transitory fashion.

Mass storage device 828 may store an operating system utilized to control the operation of the computing device 800. According to one embodiment, the operating system comprises a version of the LINUX operating system. According to another embodiment, the operating system comprises a version of the WINDOWS SERVER operating system from the MICROSOFT Corporation. According to further aspects, the operating system may comprise a version of the UNIX operating system. Various mobile phone operating systems, such as IOS and ANDROID, may also be utilized in some embodiments. It should be appreciated that other operating systems may also be utilized. Mass storage device 828 may store other system or application programs and data utilized by computing device 800.

Mass storage device 828 or other computer-readable storage media may also be encoded with computer-executable instructions, which, when loaded into computing device 800, transforms the computing device from a general-purpose computing system into a special-purpose computer capable of implementing the aspects described herein. These computer-executable instructions transform computing device 800 by specifying how CPU(s) 804 transition between states, as described above. Computing device 800 may have access to computer-readable storage media storing computer-executable instructions, which, when executed by computing device 800, may perform operating procedures shown by FIGS. 5, 6, and 7.

A computing device 800 may also include an input/output controller 832 for receiving and processing input from a number of input devices, such as a keyboard, a mouse, a touchpad, a touch screen, an electronic stylus, or other type of input device. Similarly, input/output controller 832 may provide output to a display, such as a computer monitor, a flat-panel display, a digital projector, a printer, a plotter, or other type of output device. It will be appreciated that computing device 800 may not include all of the components shown in FIG. 8, may include other components that are not explicitly shown in FIG. 8, or may utilize an architecture completely different than that shown in FIG. 8.

As described herein, a computing device may be a physical computing device, such as computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods and systems. This applies to all aspects of this application including, but not limited to, operations in disclosed methods. Thus, if there are a variety of additional operations that can be performed it is understood that each of these additional operations can be performed with any specific embodiment or combination of embodiments of the disclosed methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations can be made without departing from the scope or spirit of the present disclosure. Other embodiments will be apparent to those skilled in the art from consideration of the specification and practices disclosed herein. It is intended that the specification and example figures be considered as exemplary only, with a true scope and spirit being indicated by the following claims.

1. A method comprising:
receiving information associated with first content, wherein the information is indicative of initiating output of additional content via one or more devices of a plurality of devices;
receiving information indicating that output of the first content via a first device of the plurality of devices has reached a point in time in the first content that is associated with a first event;
sending, based at least in part on the receiving the information indicating that the output of the first content via the first device of the plurality of devices has reached the point in time in the first content that is associated with the first event, instructions to initiate output of second content via a second device of the plurality of devices; and
sending information indicative of modified output of the first content via the first device until output of the second content via the second device has ended.

2. The method of claim 1, further comprising:
receiving a set of facts associated with a user of both of the first device and the second device; and
determining to send the instructions to initiate output of the second content via the second device based at least in part on determining that the set of facts corresponds to a first rule of a set of rules associated with the first content.

3. The method of claim 1, wherein the modified output of the first content comprises at least one of causing output of the first content via the first device to be paused, causing output of the first content via the first device to be stretched, causing output of the first content via the first device to be delayed, causing output of the first content via the first device to be extended, causing a repeating portion of content to be output via the first device, and causing tertiary content to be output via the first device.

4. The method of claim 1, further comprising:
activating a rules engine based at least in part on information indicative of availability of the second device for output of secondary content.

5. The method of claim 1, further comprising:
receiving information indicative of availability of the second device for output of content associated with the first content.

6. The method of claim 1, further comprising:
receiving information indicative of a user-initiated event; and
adjusting a state of a rule engine based on the user-initiated event.

7. The method of claim 1, further comprising:
storing information indicative of a state of a rules engine, wherein the information stored is accessible based on information identifying a user of the first device and information identifying the first content.

8-20. (canceled)

21. An apparatus comprising:
a processor; and
a memory storing instructions that, when executed by the processor, cause the apparatus to:
receive information associated with first content, wherein the information is indicative of initiating output of additional content via one or more devices of a plurality of devices;
receive information indicating that output of the first content via a first device of the plurality of devices has reached a point in time in the first content that is associated with a first event;
send, based at least in part on the receiving the information indicating that the output of the first content via the first device of the plurality of devices has reached the point in time in the first content that is associated with the first event, instructions to initiate output of second content via a second device of the plurality of devices; and
send information indicative of modified output of the first content via the first device until output of the second content via the second device has ended.

22. The apparatus of claim 21, wherein the instructions, when executed, further cause the apparatus to:
receive a set of facts associated with a user of both of the first device and the second device; and
determine to send the instructions to initiate output of the second content via the second device based at least in part on determining that the set of facts corresponds to a first rule of a set of rules associated with the first content.

23. The apparatus of claim 21, wherein the modified output of the first content comprises at least one of causing output of the first content via the first device to be paused causing output of the first content via the first device to be stretched, causing output of the first content via the first device to be delayed, causing output of the first content via the first device to be extended, causing a repeating portion of content to be output via the first device, and causing tertiary content to be output via the first device.

24. The apparatus of claim 21, wherein the instructions, when executed, further cause the apparatus to:
activate a rules engine based at least in part on information indicative of availability of the second device for output of secondary content.

25. The apparatus of claim 21, wherein the instructions, when executed, further cause the apparatus to:
receive information indicative of availability of the second device for output of content associated with the first content.

26. The apparatus of claim 21, wherein the instructions, when executed, further cause the apparatus to:
receive information indicative of a user-initiated event; and
adjust a state of a rule engine based on the user-initiated event.

27. The apparatus of claim 21, wherein the instructions, when executed, further cause the apparatus to:
store information indicative of a state of a rules engine, wherein the information stored is accessible based on information identifying a user of the first device and information identifying the first content.

28. A computer-readable storage medium storing instructions that, when executed by a processor, cause an apparatus to:
receive information associated with first content, wherein the information is indicative of initiating output of additional content via one or more devices of a plurality of devices;
receive information indicating that output of the first content via a first device of the plurality of devices has reached a point in time in the first content that is associated with a first event;
send, based at least in part on the receiving the information indicating that the output of the first content via the first device of the plurality of devices has reached the point in time in the first content that is associated with the first event, instructions to initiate output of second content via a second device of the plurality of devices; and
send information indicative of modified output of the first content via the first device until output of the second content via the second device has ended.

29. The computer-readable storage medium of claim 28, wherein the instructions, when executed, further cause the apparatus to:
receive a set of facts associated with a user of both of the first device and the second device; and
determine to send the instructions to initiate output of the second content via the second device based at least in part on determining that the set of facts corresponds to a first rule of a set of rules associated with the first content.

30. The computer-readable storage medium of claim 28, wherein the modified output of the first content comprises at least one of causing output of the first content via the first device to be paused causing output of the first content via the first device to be stretched, causing output of the first content via the first device to be delayed, causing output of the first content via the first device to be extended, causing a repeating portion of content to be output via the first device, and causing tertiary content to be output via the first device.

31. The computer-readable storage medium of claim 28, wherein the instructions, when executed, further cause the apparatus to:
activate a rules engine based at least in part on information indicative of availability of the second device for output of secondary content.

32. The computer-readable storage medium of claim 28, wherein the instructions, when executed, further cause the apparatus to:
receive information indicative of availability of the second device for output of content associated with the first content.

33. The computer-readable storage medium of claim 28, wherein the instructions, when executed, further cause the apparatus to:
receive information indicative of a user-initiated event; and
adjust a state of a rule engine based on the user-initiated event.
